(19) United States
(12) Patent Application Publication
(10) Pub. No.: US 2007/0060210 A1
(43) Pub. Date: Mar. 15, 2007

(54) Strap attached with a cell unit

(75) Inventors: Shih-Hui Chen, Taoyuan Hsieh (TW); Chin-Tien Lin, Taoyuan Hsieh (TW)

Correspondence Address: TROXELL LAW OFFICE PLLC, SUITE 1404, 5205 LEESBURG PIKE, FALLS CHURCH, VA, 22041, US

(73) Assignee: Tennrich International Corp.

(21) Appl. No.: 11/195,706

(22) Filed: Aug. 3, 2005

(51) Int. Cl. H04B 1/38

(52) U.S. Cl. 455/572

(57) ABSTRACT

A strap of a bag containing an electronic product such as a notebook, PDA, or cellular phone, is attached with a cell unit; the a cell unit connected and supplying power to the electronic product by means of a or a plurality of connection member.

### BACKGROUND OF THE INVENTION

(a) Field of the Invention

The present invention is related to a strap attached with a cell unit, and more particularly to a strap of a bag containing an electronic product that is attached with a cell unit to supply power to an electronic product.

(b) Description of the Prior Art

In coping with the needs of fast access to information and data process by the consumer today, various types of electronic products have been generally available in the market. Among those electronic products, notebook is the most popular and to its user, a multi-purpose carry-on bag is a must to hold a number of peripherals (a charger, modem, etc.) along with the notebook. The interior design of a carry-on bag that meets the needs of the user therefore becomes very important. For example, design of the inside pockets to accommodate those peripherals in order is critical to the design of the multi-purpose carry-on bag.

### SUMMARY OF THE INVENTION

The primary purpose of the present invention is to provide a strap of a carry-on bag that is provided at where appropriately a cell unit, which is connected with one or a plurality of attachment to an electronic product accommodated in the carry-on bag to supply power to the electronic product while allowing extra space available inside the carry-on bag.

### BRIEF DESCRIPTION OF THE DRAWINGS

FIG. 1 is a perspective view of a construction of strap attached with a cell unit of the present invention.

FIG. 2 is a perspective view of a first preferred embodiment of the present invention.

FIG. 3 is a perspective view of a second preferred embodiment of the present invention.

FIG. 4 is a magnified view of a porch and a cell unit of the first preferred embodiment of the present invention.

FIG. 5 is a schematic view showing an operation status of the present invention.

FIG. 6 is a schematic view showing a construction of a temperature sensor of the present invention.

### DETAILED DESCRIPTION OF THE PREFERRED EMBODIMENTS

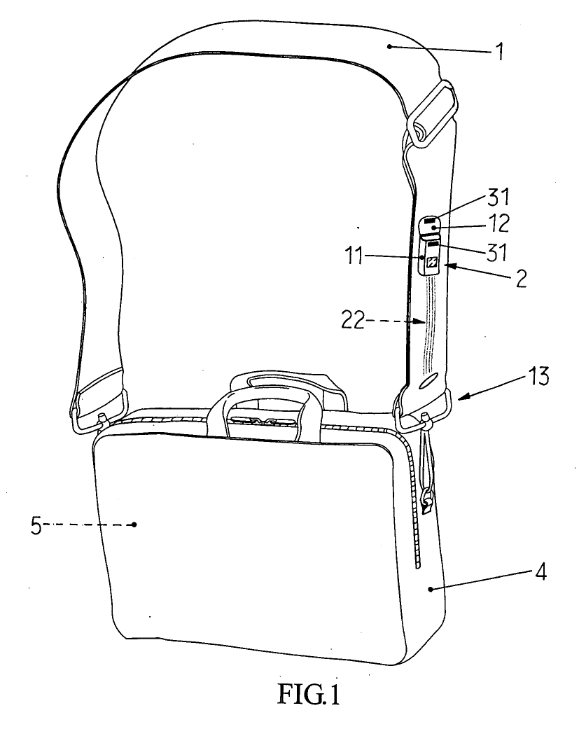

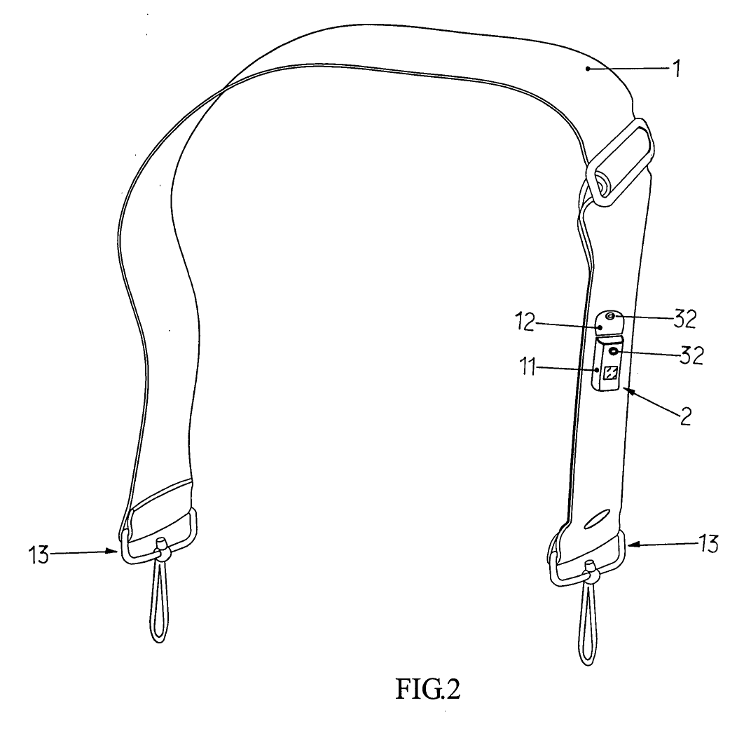

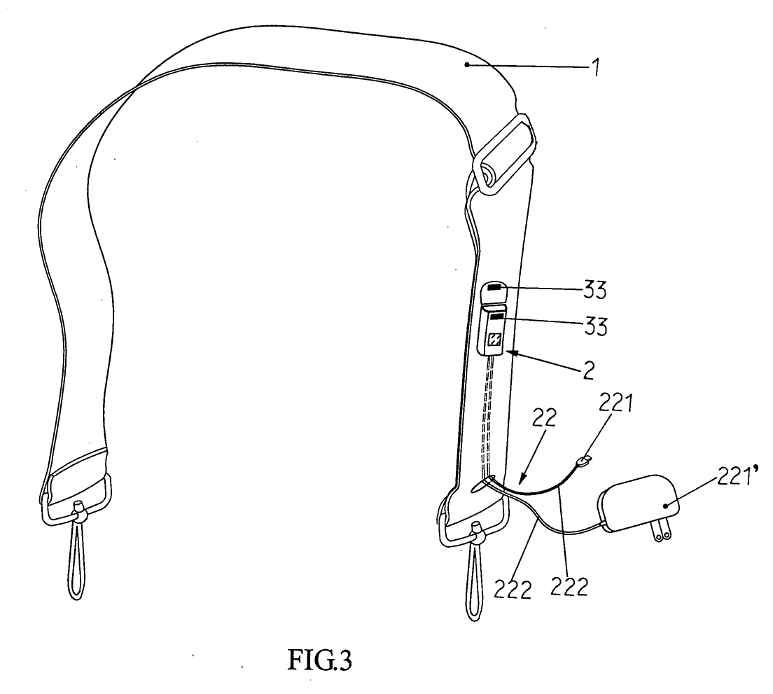

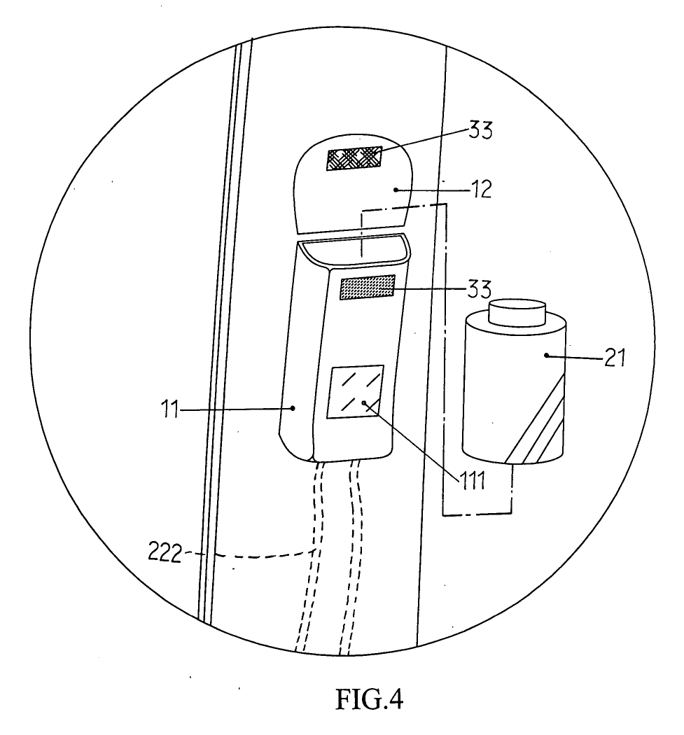

Referring to FIG. 1, the present invention is essentially comprised of a strap 1 attached at where appropriately an accommodation part 11 to contain a cell unit 2. A flap 12 is disposed above the accommodation part. 11 to cover up the cell unit 2. The flap 12 is attached to the accommodation part 11 by means of a magnet. The strap 1 has its both ends connected to a bag 4 by means of two fasteners 13 to form a multi-purpose carry-on bag for containing an electronic product or other objects. The flap 12 is attached to the accommodation part 11 by means of a fastener 32 as shown in FIG. 2, or by means of a magic tape 33 as illustrated in FIGS. 3 and 4. The cell unit 2 may include one or a plurality of battery 21 and a circuit board (not illustrated). The case of the battery is molded with additive of silicon gel to make the case comparatively resilient and allowing variation of its appearance as desired. The cell unit 2 is connected to one or a plurality of attachment 22 containing a USB connector 221 or a power adapter 221′, and a pair of connection line 222 built in the strap with its terminal exposed out of the strap 1.

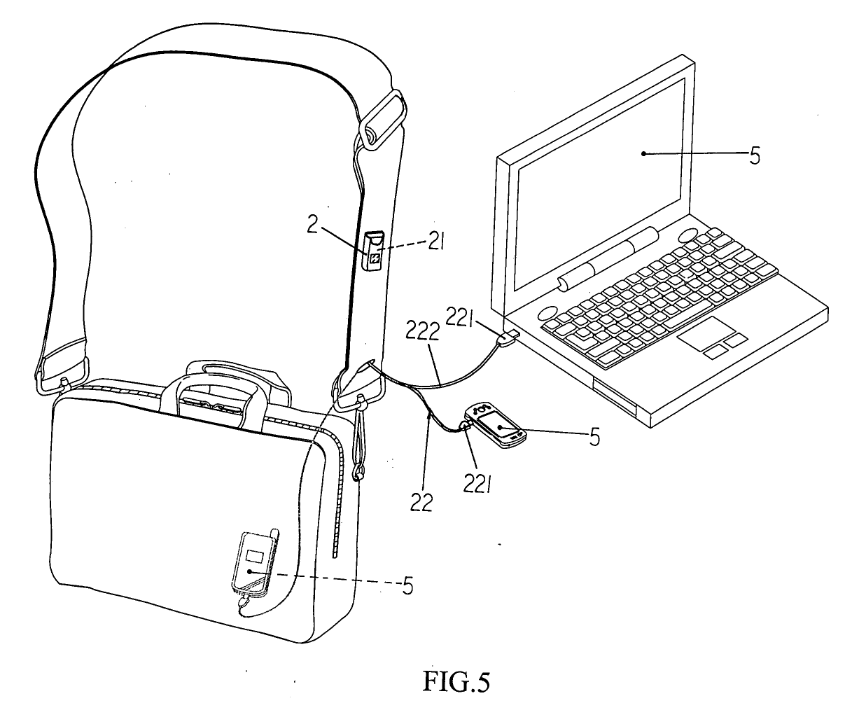

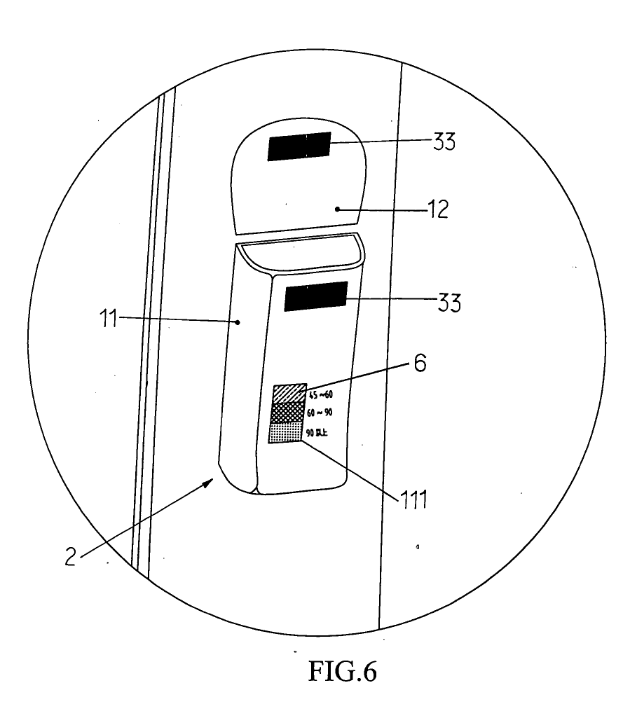

When each USB connector 221 of the attachment 22 is inserted into an electronic product 5 (e.g., a notebook, PDA or a cellular phone) as illustrated in FIG. 5, the power stored in each battery 21 of the cell unit 2 is supplied through the connection line 222 to the electronic product 5 to make up the power or maintain 5 the normal operation of the electronic product 5. The cell unit 2 may have the power adapter 221′ as illustrated in FIG. 3 to be inserted into a city power socket to charge the battery 21 in the cell unit 2. A temperature sensor 6 is provided to the cell unit 2 and a window 111 is formed on the accommodation part 11 for the 10 sensor 6 to be visible as illustrated in FIG. 6. The temperature sensor 6 may be related to a sticker or gel adhered to the outer surface of the cell unit 2 for the temperature sensor 6 to change its color depending on the temperature change as detected. For example, a first color to display is defined for the temperature is range between 45˜60° C.; a second color, 60˜90° C.; and a third color, higher than 90° C. to have solid command of the temperature of each battery to prevent possible explosion due to excessively higher charging temperature.

The present invention provides the following advantages:

1. Providing extra capacity for the carry-on bag since the cell unit is attached to the strap of the carry-on bag;

2. Allowing the use of a connector to charge the electronic product placed in the carry-on bag at any time for the user to charge and operate the electronic product at the same time while he's walking or outdoors;

3. Permitting easy sorting of the connection lines without tangling them in a mess since the accommodation part of the cell unit is directly provided on the strap and the connection lines of the cell unit is built in the strap; and

4. Ergonomically designed of the battery contained in the accommodation part for the user to feel easy by carrying the bag on shoulder or by hand since silicon gel is added to the case of each battery in the molding process to make the case more resilient and allowing modification of its appearance as desired.

The prevent invention provides an improved structure of a strap attached with a cell unit to supply power to an electronic product contained in the bag, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A strap attached with a cell unit includes a cell unit disposed at where appropriately on the strap and the cell unit is connected with one or a plurality of attachment.

2. The strap attached with a cell unit of claim 1, wherein the strap is connected to a carry-on bag containing an electronic product.

3. The strap attached with a cell unit of claim 2, wherein the strap is connected to the carry-on bag by means of a pair of fasteners.

4. The strap attached with a cell unit of claim 1, wherein an accommodation part is disposed at where appropriately on the strap for the installation of the cell unit, and a flap is provided above the accommodation part.

5. The strap attached with a cell unit of claim 4, wherein the flap is attached to the accommodation part by means of a magnet.

6. The strap attached with a cell unit of claim 4, wherein the flap is attached to the accommodation part by means of a magic tape.

7. The strap attached with a cell unit of claim 4, wherein the flap is attached to the accommodation part by means of a buckle.

8. The strap attached with a cell unit of claim 4, wherein a temperature sensor is disposed at the cell unit, and a window is formed on the accommodation part to expose the temperature sensor.

9. The strap attached with a cell unit of claim 1, wherein the case of each battery placed in the cell unit is added with silicon gel.

10. The strap attached with a cell unit of claim 2, wherein an accommodation part is disposed at where appropriately on the strap for the installation of the cell unit, and a flap is provided above the accommodation part.

11. The strap attached with a cell unit of claim 10, wherein the flap is attached to the accommodation part by means of a magnet.

12. The strap attached with a cell unit of claim 10, wherein the flap is attached to the accommodation part by means of a magic tape.

13. The strap attached with a cell unit of claim 10, wherein the flap is attached to the accommodation part by means of a buckle.

14. The strap attached with a cell unit of claim 10, wherein a temperature sensor is disposed at the cell unit, and a window is formed on the accommodation part to expose the temperature sensor.
